(19) United States
(12) Patent Application Publication
(10) Pub. No.: US 2022/0201527 A1
(43) Pub. Date: Jun. 23, 2022

(54) USER TERMINAL AND RADIO COMMUNICATION METHOD

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 17/604,642

(22) PCT Filed: Apr. 26, 2019
(86) PCT No.: PCT/JP2019/018124

§ 371 Date: Oct. 18, 2021

(51) Int. Cl. H04W 24/10

(52) U.S. Cl. CPC H04W 24/10

(57) ABSTRACT

A terminal according to an aspect of the present disclosure includes a receiving section that receives, from at least one of a first network and a second network of a business operator different from a business operator for the first network, information related to a resource for measurement in the second network, and a control section that controls so as to report, to at least one of the first network and the second network, information including a result of measurement by the resource for measurement.

### TECHNICAL FIELD

The present disclosure relates to a user terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (also referred to as, for example, “5th generation mobile communication system (5G),” “5G+ (plus),” “New Radio (NR),” “New radio access (NX),” “Future generation radio access (FX),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (e.g., NR), a system that allows not only a communication carrier (operator) licensed for a given frequency domain but also a business operator other than the communication carrier to operate 5G systems under limited conditions is under study.

In this case, it is also assumed that a plurality of networks of different business operators is operated in the given frequency domain. It is conceivable that a transmission and reception point (e.g., a base station) and the like are arranged without mutual coordination or linkage between networks operated by the different business operators. Therefore, mutual interference between the networks of different business operators may occur, and thus communication quality may deteriorate.

Thus, an object of the present disclosure is to provide a user terminal and a radio communication method that can suppress deterioration in communication quality due to interference between networks of different business operators.

### Solution to Problem

A user terminal according to an aspect of the present disclosure includes: a receiving section that receives, from at least one of a first network and a second network of a business operator different from a business operator for the first network, information related to a resource for measurement in the second network; and a control section that controls information including a result of measurement by the resource for measurement to be reported to at least one of the first network and the second network.

### Advantageous Effects of Invention

According to an aspect of the present disclosure, it is possible to suppress deterioration in communication quality due to interference between networks of different business operators.

### BRIEF DESCRIPTION OF DRAWINGS

FIG. 1 is a diagram to show an example of frequency band allocation to a business operator;

FIG. 2 is a diagram to show an example of a frequency domain to which a local NW is allocated;

FIGS. 3A and 3B are diagrams to show an example of interference occurred between NWs of different business operators;

FIGS. 4A and 4B are diagrams to show an example of control of interference between different NWs;

FIGS. 5A and 5B are diagrams to show another example of control of interference between different NWs;

FIGS. 6A and 6B are diagrams to show another example of control of interference between different NWs;

FIG. 7 is a diagram to show another example of control of interference between different NWs;

FIG. 8 is a diagram to show an example of leakage interference occurred between different NWs;

FIG. 9 is a diagram to show an example of an MPR configuration method;

FIG. 10 is a diagram to show an example of a schematic structure of a radio communication system according to one embodiment;

FIG. 11 is a diagram to show an example of a structure of a base station according to one embodiment;

FIG. 12 is a diagram to show an example of a structure of a user terminal according to one embodiment; and

FIG. 13 is a diagram to show an example of a hardware structure of the base station and the user terminal according to one embodiment.

### DESCRIPTION OF EMBODIMENTS

For future radio communication systems (e.g., NR or Rel. 17 (or later versions)), not only a communication carrier (e.g., a first business operator) licensed for a given frequency band but also a business operator other than the communication carrier that operates a 5G system is under study. For example, the business operator (e.g., a second business operator) other than the communication carrier may be a company and the like that hope to utilize 5G technology as a self-managed radio for industrial purposes. Limiting a communication condition (e.g., an area, a station installation, or the like) for the second business operator to individually license the second business operator is also under study.

A network that is operated by the first business operator licensed for the given frequency band (referred to as, for example, a licensed band) may be referred to as a first network, a 5G licensed network, a licensed 5G network, a licensed network, or a communication carrier network.

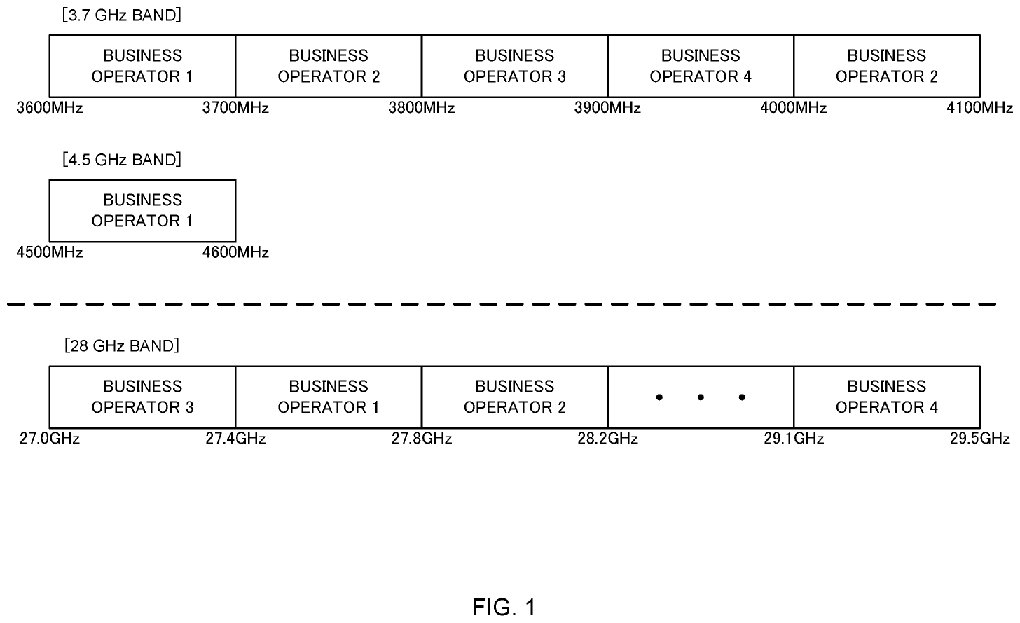

FIG. 1 is a diagram to show an example of frequency band allocation to the first business operator. As shown in FIG. 1, it is assumed that a license is allocated to a specific business operator in each frequency band. Here, the first business operator is described using different business operators 1 to 4 as examples thereof, but the number of business operators or frequency allocation of the present disclosure is not limited to this.

A network operated by the second business operator may be referred to as a second network, a local 5G network, a 5G local network, a local network, a limited station installation network, a limited area network, or a non-communication-carrier operator network. A communication condition of the second network may be more limited as compared to that of the first network. For example, the second network may be a structure that is more limited in an area in which a transmission and reception point (e.g., a base station) is installed (for example, can be installed only indoors), as compared to that of the first network, or may be a structure limited in transmit power.

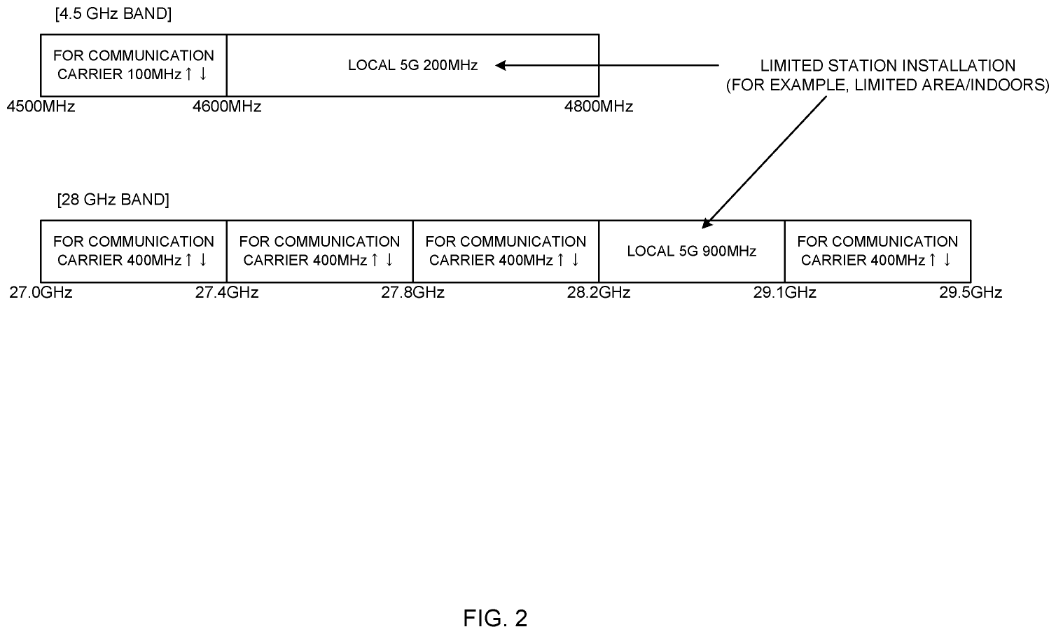

FIG. 2 shows an example of frequency bands allocated to the local 5G network operated by the second business operator. Here, FIG. 2 shows a case where the local 5G network is operated in a frequency band being different from that allocated to the first business operator (e.g., being adjacent to a frequency band allocated to the first business operator).

Note that the frequency band in which the local 5G network can be operated is not limited to this. For example, the local 5G network limited in a communication condition may be operated in a licensed frequency band of the first business operator. The local 5G network (second network) may be operated by the first business operator.

A UE connects to at least one of the first network (hereinafter also described as a licensed NW) and the second network (hereinafter also described as a local NW).

For example, the UE may perform communication (e.g., carrier aggregation (CA) or dual connectivity (DC)) by simultaneously connecting to the local NW and the licensed NW. Alternatively, the UE may be a structure that does not perform, for the duration of connection to one NW (e.g., the local NW), transmission and reception of data in another NW (e.g., the licensed NW).

The local NW and the licensed NW may be configured in the same frequency domain or component carrier (CC), or may be configured in different frequency domains or CCs. An unlicensed band may be applied to the local NW.

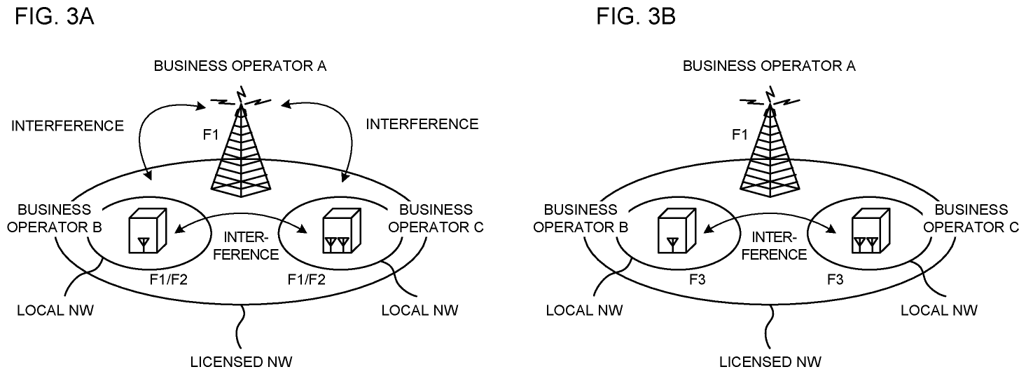

As described above, when networks of different business operators are operated in adjacent frequency bands or a common frequency band, interference between the networks may occur. For example, when a frequency band common to the first business operator and the second business operator (or adjacent frequency bands) is applied, interference may occur between the licensed NW and the local NW (see FIG. 3A). FIG. 3A shows an example of a case where interference occurs between a business operator A that operates the licensed NW in a first frequency band (F1), and a business operator B and business operator C that operate the local NW in at least one of the F1 and a second frequency band (F2).

When a frequency band common to the second business operator (or adjacent frequency bands) is applied, interference may also occur between local NWs (see FIG. 3B). FIG. 3B shows an example of a case where interference occurs between the business operators B and C operating the local NWs in a third frequency band (F3).

As shown in FIGS. 3A and 3B, when a plurality of networks (or cells) of different business operators is operated in a common frequency band or adjacent frequency bands, interference from another business operator may occur. In particular, it is also assumed that a transmission and reception point (e.g., a base station) and the like are arranged without mutual coordination or linkage between networks of different business operators, and thus it is difficult to control interference in linkage or coordination between different NWs.

The inventors of the present invention focused on the difficulty in controlling interference through cooperation or coordination between different NWs, and came up with the idea of the invention of the present application by studying a control method for reducing the interference between NWs.

Embodiments according to the present disclosure will be described in detail with reference to the drawings as follows. Structures described in respective aspects of embodiments may each be employed individually, or may be employed in combination. Note that a communication system in which the present embodiment can be employed is not limited.

In descriptions below, networks of different business operators are described using a licensed NW and a local NW as an example of the networks, but classes or types of NWs are not limited to this. Descriptions below are described using a plurality of NWs with different business operators as an example, but the present disclosure can be employed in control of interference between NWs with the same business operator.

In the present disclosure, networks of the same business operator may be interpreted as networks with the same business operator ID. Networks of different business operators may be interpreted as networks with different business operator IDs. Networks of different business operators may also be interpreted as networks that are at least different from each other in terms of cell ID (virtual cell IDs). Networks of different business operators may also be interpreted as networks that are at least different from each other in terms of locations of a transmission resource for an SSB and broadcast information. A network may be interpreted as a cell or a component carrier (CC).

### (First Aspect)

In a first aspect, when a given NW receives interference from another NW, the given NW is controlled so as to suppress the interference autonomously in the given NW. The first aspect can be preferably employed in a case where interference control is not actively performed in cooperation with a network of another business operator.

When a given NW (e.g., a local NW) receives interference from another NW (licensed NW or another local NW of a different business operator), the local NW may control so as to autonomously suppress interference in its own NW. Control for suppressing interference may be at least one of transmit power control, beam control, physical channel (e.g., at least one of a shared channel or a control channel) resource control.

For example, the local NW may configure a resource for measurement used for measurement of interference from another NW for a UE, and may control so as to receive information related to a result of the measurement by the measurement resource from the UE. When judging that the local NW receives strong interference from another NW (e.g., interference power, SINR, or RSRQ is a given value or more) on the basis of the result of the measurement reported from the UE, the local NW may control so as to autonomously suppress interference from its own NW.

The UE may assume that a resource (also referred to as a resource for interference measurement or an IMR resource) used for measurement of interference from another NW is configured. The resource for interference measurement may be a resource in which a given signal (e.g., at least one of a synchronization signal block and a CSI-RS) is transmitted.

The UE may measure at least one of signal power, interference power, RSRP, RSRQ, SINR, CSI, and CQI of NWs (or cells) with different business operator IDs. The UE may report a flag (e.g., 1 bit) indicating whether a result of the measurement is a given value or more. Alternatively, the UE may report a result of measurement of at least one of signal power, interference power, RSRP, RSRQ, SINR, and CQI of NWs (or cells) with different business operator IDs.

The UE may report a result of measurement of the configured resource to a NW (e.g., a local NW) to be connected.

Note that the UE may perform measurement without understanding that which business operator (or network) a configured resource for interference measurement corresponds to. In this case, by associating a given business operator with the resource for interference measurement configured for the UE, as well as notifying a base station of information about the resource to measure from the UE, a network that gives interference to the UE can be judged on the base station side.

The UE may assume to be controlled so as to suppress interference to another NW on the basis of the reported measurement result. The control for suppressing the interference may be at least one of beam control, control of a TPC parameter, control of a TPC command, control of DL transmit power (e.g., EPRI), scheduling control, resource control (e.g., a CDM group, RE, or a sequence length), control of a cell index (e.g., a sequence index or a cyclic shift index).

When receiving interference from another NW, it is conceivable that its own NW is highly likely to give interference to another NW. Accordingly, when receiving interference from another NW, each NW controls so as to suppress interference to another NW in its own NW, thereby allowing an increase in interference between the NWs to be suppressed. Therefore, the interference between the NWs can be suppressed even when active interference control through cooperation between the NWs is not supported.

### (Second Aspect)

In a second aspect, when a given NW receives interference from another NW, information related to the interference is notified to perform interference control. Notification of information related to interference control or interference may be performed using a given NW, or may be directly performed for another NW.

### <Notification of Interference Information to Licensed NW>

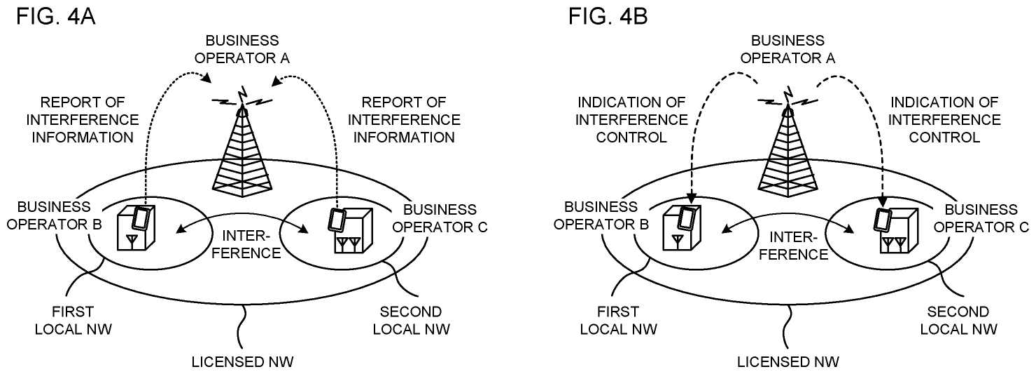

FIG. 4 shows an example of a case where when interference occurs between a plurality of NWs (e.g., a first local NW and a second local NW of different business operators), the interference between the plurality of the NWs is controlled via still another NW (e.g., a licensed NW). FIG. 4A shows a case where interference that occurs between the first local NW (business operator B) and the second local NW (business operator C) is controlled using the licensed NW (business operator A).

The UE connecting to a local NW may report at least a piece of information related to interference in the local NW to the licensed NW. For example, the UE connecting to the first local NW reports a result of measurement by using a given resource as a piece of interference information (or a measurement report) to the licensed NW.

At least one of the licensed NW and the first local NW may configure a resource (also referred to as a resource for interference measurement or an IMR resource) used for interference measurement for the UE. The resource for interference measurement may be a resource in which a given signal (e.g., at least one of a synchronization signal block and a CSI-RS) is transmitted.

The UE may measure at least one of signal power, interference power, RSRP, RSRQ, SINR, CSI, and CQI of NWs (or cells) with different business operator IDs. The UE may report a flag (e.g., 1 bit) indicating whether a result of the measurement is a given value or more. Alternatively, the UE may report a result of measurement of at least one of signal power, interference power, RSRP, RSRQ, SINR, and CQI of NWs (or cells) with different business operator IDs.

The UE may include information related to an index of a resource (IMR resource) that has been used for the measurement in contents of the report. The UE may perform control so as to report to the licensed NW only when the interference information exceeds a given value.

Note that the UE may perform measurement without understanding that which business operator (or network) a configured resource for interference measurement corresponds to. In this case, by associating a given business operator with the resource for interference measurement configured for the UE, as well as notifying a base station of information about the resource to measure from the UE, a network that gives interference to the UE can be judged on the base station side.

At least one of the licensed NW and the first local NW may configure, for the UE, a resource (referred to as a resource for a report) used for a report to the licensed NW by the UE.

In addition to the interference information (or measurement result, measurement report), the UE may notify a request for interference reduction. The request for interference reduction may be a request for reduction of interference to at least one of a specific beam, cell, network, transmission and reception point, base station, and IMR resource.

The licensed NW may control interference between NWs on the basis of information reported from the UE. For example, when interference information reported from the UE connecting to the first local NW exceeds a given value, the licensed NW may control interference from the second local NW to the first local NW to be reduced.

In other words, the UE connected to the local NW may be indicated to perform interference control by the licensed NW. For example, interference control is performed for the UE so as not to give interference to a specific frequency domain (or CC) from the licensed network. The specific frequency domain (or CC) may include at least one of a frequency domain in which the licensed NW is operated and a frequency domain in which another local NW is operated.

For example, the licensed NW may perform control of reduction of interference to the first local NW (or the UE connecting to the first local NW) for the UE connecting to the second local NW (see FIG. 4B). Alternatively, the licensed NW may perform control of reduction of interference to the first local NW (or the UE connecting to the first local NW) for the second local NW (e.g., the base station).

Similarly, when interference information reported from the UE connecting to the second local NW exceeds a given value, the licensed NW may control interference from the first local NW to the second local NW so as to reduce the interference.

The interference control performed by the licensed NW may be at least one of beam control, control of a TPC parameter, control of a TPC command, control of DL transmit power (e.g., EPRI), scheduling control, resource control (e.g., a CDM group, RE, or a sequence length), control of a cell index (e.g., a sequence index or a cyclic shift index).

For example, when interference information is reported from the UE connecting to the first local NW, the licensed NW indicates, on the basis of the interference information, to perform any one of the above-mentioned interference control to at least one of the second local NW and the UE connecting to the second local NW.

When indicating to perform the interference control to the second local NW (or the UE connecting to the second local NW), a part of the interference control may be notified from the licensed NW, and the rest of the interference control may be notified from the second local NW.

Alternatively, when performing the interference control in the second local NW (or the UE connecting to the second local NW), the interference control may be indicated from both the licensed NW and the second local NW. In this case, the UE may control transmission and reception on the basis of the latest notified contents.

Alternatively, when different interference control is notified from the licensed NW and the second local NW, the UE may prioritize an indication from either the licensed NW or the second local NW. For example, when being notified from the licensed NW, the UE may ignore contents subsequently notified from the local NW (prioritize the notification from the licensed NW). Alternatively, when being notified from the local NW, the UE may ignore contents subsequently notified from the licensed NW (prioritize the notification from the local NW).

As described above, at least some of the interference control in the local NW is performed by the licensed NW, and thus the interference control can be flexibly performed on the basis of an interference condition in each local NW.

### <Notification of Interference Information to Local NW>

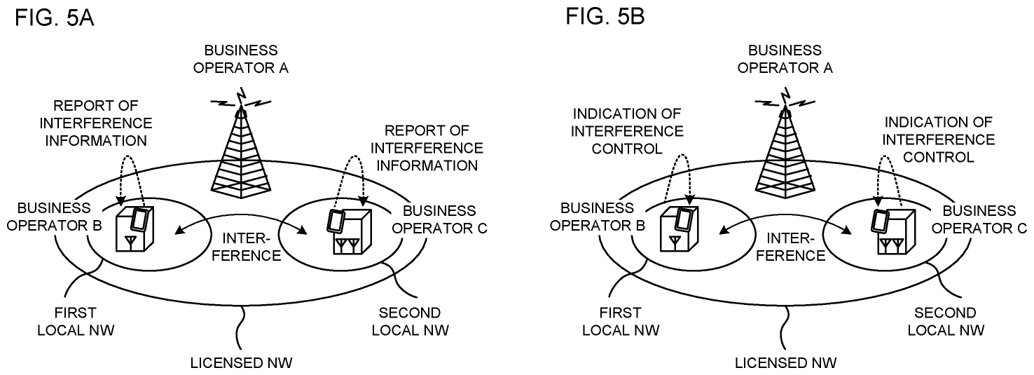

FIG. 5 shows an example of a case where when interference occurs between a plurality of NWs (e.g., a first local NW and a second local NW of different business operators), the interference between the NWs is controlled using the local NW. FIG. 5A shows a case where interference that occurs between the first local NW (business operator B) and the second local NW (business operator C) is controlled using at least one of the first local NW and the second local NW.

The UE connecting to a local NW may report information related to interference in the local NW to the local NW. For example, the UE connecting to the first local NW reports a result of measurement by using a given resource as a piece of interference information (or a measurement report) to the first local NW.

At least one of the licensed NW and the first local NW may configure a resource (also referred to as a resource for interference measurement or an IMR resource) used for interference measurement for the UE. The resource for interference measurement may be a resource in which a given signal (e.g., at least one of a synchronization signal block and a CSI-RS) is transmitted. The resource for interference measurement may be a resource for measurement of interference from another local NW (e.g., the second local NW).

The UE may measure at least one of signal power, interference power, RSRP, RSRQ, SINR, CSI, and CQI of NWs (or cells) with different business operator IDs. The UE may report a flag (e.g., 1 bit) indicating whether a result of the measurement is a given value or more. Alternatively, the UE may report a result of measurement of at least one of signal power, interference power, RSRP, RSRQ, SINR, and CQI of NWs (or cells) with different business operator IDs.

The UE may include information related to an index of a resource (IMR resource) that has been used for the measurement in contents of the report. The UE may be controlled so as to report to the local NW only when the interference information exceeds a given value.

Note that the UE may perform measurement without acknowledging that which business operator (or network) a configured resource for interference measurement corresponds to. In this case, by associating a given business operator with the resource for interference measurement configured for the UE, as well as notifying information about the resource to measure from the UE to a base station, a network that gives interference to the UE can be judged on the base station side.

At least one of the licensed NW and the first local NW may configure a resource (referred to as a resource for a report) used for a report to the local NW by the UE for the UE.

In addition to the interference information (or measurement result, measurement report), the UE may notify a request for interference reduction. The request for interference reduction may be a request for reduction of interference to at least one of a specific beam, cell, network, transmission and reception point, base station, and IMR resource.

The first local NW may control interference between the first local NW and another NW on the basis of information reported from the UE (see FIG. 5B). For example, when interference information reported from the UE connecting to the first local NW exceeds a given value, the first local NW may control interference from the second local NW to the first local NW so as to reduce the interference.

When information can be directly shared between the first local NW and the second local NW, mutual interference information may be shared with each other to control transmission and reception conditions in each local NW. When information cannot be directly shared between the first local NW and the second local NW, mutual interference information may be shared with each other via another NW (e.g., the licensed NW).

The UE connected to the local NW may be indicated to perform interference control by the local NW. For example, interference control may be performed for the UE so as not to give interference to a specific frequency domain (or CC) from the local NW.

The interference control performed by the local NW may be at least one of beam control, control of a TPC parameter, control of a TPC command, control of DL transmit power (e.g., EPRI), scheduling control, resource control (e.g., a CDM group, RE, or a sequence length), control of a cell index (e.g., a sequence index or a cyclic shift index).

When indicating to perform the interference control to the first local NW (or the UE connecting to the first local NW), a part of the interference control may be notified from the licensed NW, and the rest of the interference control may be notified from the first local NW.

Alternatively, when performing the interference control in the first local NW (or the UE connecting to the first local NW), the interference control may be indicated from both the licensed NW and the first local NW. In this case, the UE may control transmission and reception on the basis of the latest notified contents.

Alternatively, when different interference control is notified from the licensed NW and the first local NW, the UE may prioritize an indication from either the licensed NW or the first local NW. For example, when being notified from the licensed NW, the UE may ignore contents subsequently notified from the local NW (prioritize the notification from the licensed NW). Alternatively, when being notified from the local NW, the UE may ignore contents subsequently notified from the licensed NW (prioritize the notification from the local NW).

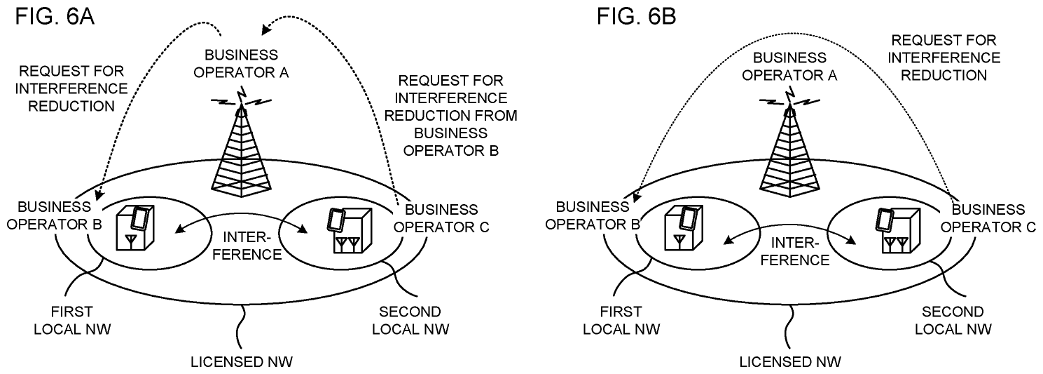

The local NW may notify a given NW (e.g., the licensed NW) of a request for interference reduction in another local NW. In this case, the licensed NW may request another local NW to reduce interference (FIG. 6A). In FIG. 6A, when the second local NW (business operator C) receives interference from another local NW (e.g., the first local NW), the second local NW notifies the licensed NW of a request for interference reduction. The licensed NW may indicate, on the basis of a report from the second local NW, to reduce interference to the first local NW.

The licensed NW may determine, on the basis of information (e.g., an index of a resource that has received interference or the like) reported from the second local NW, selection of a NW (in FIG. 6A, the first local NW) indicating interference reduction.

Alternatively, the local NW (e.g., the second local NW) may notify another local NW (e.g., the first local NW) of a request for interference reduction (see FIG. 6B). The request for interference reduction to another local NW may be performed using a specific signal or channel. Transmit power for the specific signal or channel may be configured to be higher than that for a signal or channel transmitted to the UE. Alternatively, when the local NWs are connected to each other through a back haul link, the local NW may perform the notification by using the back haul link.

### (Third Aspect)

In a third aspect, an index applied in each NW or a configuration of an index applied in each NW will be described. Descriptions below are given by using a cell index (Cell ID), a virtual cell index (Virtual Cell ID), a scramble ID, and a sequence ID as examples of the index, but the present disclosure is not limited to these. Descriptions below can be employed in each of a DL and a UL.

### <Cell ID>

Each business operator (or corresponding network) may select a cell ID (or virtual cell ID) arbitrarily from all ID (all cell ID candidates) numbers. For example, each business operator may individually select the cell ID from 0 to 1023.

Alternatively, a selectable ID range may be limited for each business operator (or corresponding network). For example, a selectable ID range for business operator A (or network A) may be configured to {0, 1, . . . 9}, and a selectable ID range for business operator B (or network B) may be configured to a range that does not overlap the selectable ID range for business operator A (e.g., {10, 11, . . . 19}).

Selectable ranges for respective business operators may be configured to the same range, or the selectable range may be configured to be different from each other for respective business operators.

### <Control of ID Allocation by Operator (Communication Carrier)>

A given NW (or operator) may control an ID configured for each NW. For example, the licensed NW may notify an ID applied in each local NW. The licensed NW may determine, on the basis of interference information reported from each local NW (or the UE connected to each local NW) and the like, the ID so as to reduce interference between the local NWs.

The UE connected to the local NW may report, to the licensed NW, information (e.g., an index of a resource that receives interference equal to or greater than a given value or the like) related to an ID (or cell ID) that receives interference. Therefore, interference between the plurality of the local NWs can be suppressed.

### <Configurable ID Range>

Depending on classes or types of networks (or business operators), an ID configurable for each network may be controlled.

For example, all of configurable IDs (e.g., 0 to 1023) may be configurable for cell IDs of the local NWs.

Alternatively, some of configurable IDs (e.g., some of 0 to 1023) may be configurable for cell IDs of the local NWs.

Alternatively, some of IDs configurable for a local NW that uses a licensed band are configurable for cell IDs of the local NW. On the other hand, all of IDs configurable for a local NW that uses a band dedicated to local NWs may be configurable for cell IDs of the local NW.

### <Configuration of ID Applied in Local NW>

An ID applied to transmission or reception in a local NW may be notified from at least one of the local NW and licensed NW to the UE.

An ID applied in the local NW may be at least one of a cell ID, a virtual cell ID, a scramble ID, and a sequence ID. The scramble ID corresponds to an ID used for generation of a scrambling sequence for a given physical channel (e.g., a PDCCH, a PDSCH, a PUSCH, a PUCCH, or the like). The sequence ID corresponds to an ID used for generation of an RS sequence for a given reference signal (e.g., a DMRS, a PTRS, a TRS, a CSI-RS, an SRS, a CRS, or the like). Alternatively, the sequence ID may be of a sequence applied to a determination of c_init used for generation of a PN sequence.

When the local NW notifies the UE of ID information, the ID information may be notified, to the UE, as some of local NW cell information. Alternatively, the ID information may be notified as some of higher layer parameters related to the local NW.

The local NW notifies the UE of the ID information, and thus the UE can judge a data scrambling sequence, an RS sequence, an RS location, or the like without using the licensed NW (e.g., even when the licensed NW is out of service).

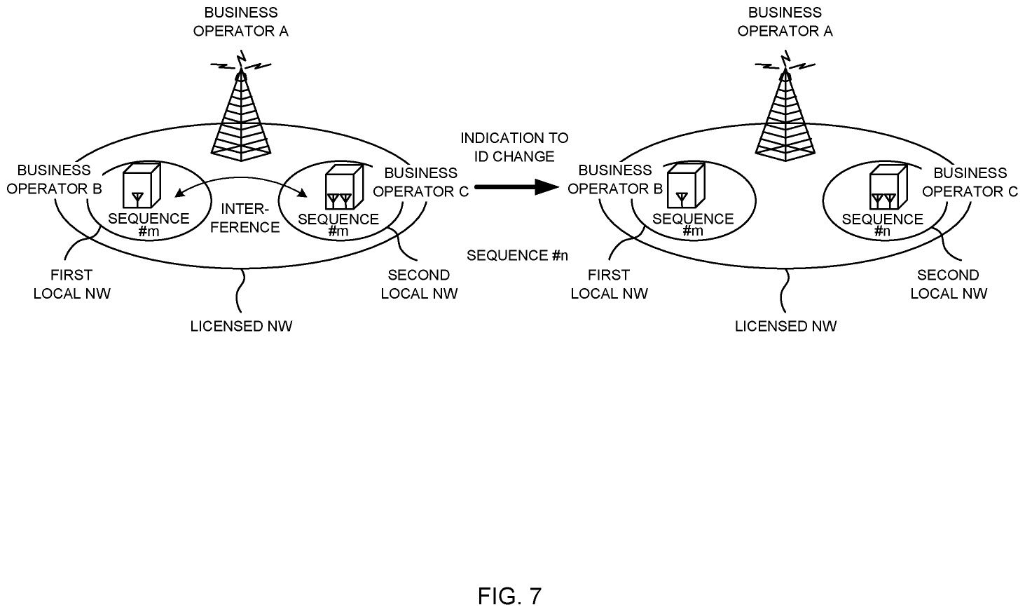

Alternatively, the licensed NW may notify the UE of ID information applied in the local NW. In this case, even when a station installation (e.g., an arrangement of transmission and reception point) in each local NW is performed without consideration of another NW, the licensed NW can configure an ID that is not used in a neighboring NW (see FIG. 7).

FIG. 7 shows a case where when the same sequence (here, sequence #m) is applied in the first local NW (business operator B) and the second local NW (business operator C), the licensed NW indicates the second local NW to change an ID.

The licensed NW may notify the UE of information related to a change or update of an ID (at least one of a cell ID, a scramble ID, and a sequence ID), or the local NW connected by the UE may notify the UE of the information. The information related to the change or update of the ID may include information related to an ID after being changed or updated, information related to a changing or updating timing, and the like.

The information related to the change or update of the ID may be notified to the UE by using at least one of higher layer signaling, MAC control information, and downlink control information. For example, the information related to an ID after being changed or updated may be included in the higher layer signaling transmitted at given intervals to notify the UE of this information. Alternatively, an ID (e.g., a cell ID) may be changed or updated by using system information for paging.

In the second local NW indicated to change the ID, the sequence (here, sequence #n) is generated on the basis of the ID after being changed, and thus interference between the first local NW and the second local NW can be suppressed.

Therefore, interference and sequence collision between local NWs can be suppressed, thereby allowing quality of communication on a data channel and control channel to be improved.

On the other hand, when ID information applied in the local NW is not notified from the licensed NW, the UE may determine an ID applied in the local NW on the basis of any one of the following.
(1) when the ID information is not notified from the licensed NW, the UE uses an ID notified from the local NW.
(2) when the ID information is not notified from the licensed NW, the UE uses a cell ID.
(3) when the ID information is not notified from both the licensed NW and the local NW, the UE uses a cell ID.

Therefore, transmission and reception in the local NW can be appropriately controlled even when the ID information is not notified from the NW.

An ID applied to transmission or reception in the licensed NW may be notified from at least one of the local NW and licensed NW to the UE. An ID applied in the licensed NW may be at least one of a cell ID, a virtual cell ID, a scramble ID, and a sequence ID.

The local NW notifies the UE of the ID information applied in the licensed NW, and thus signaling overhead for the licensed NW can be reduced. Therefore, frequency usage efficiency and throughput can be improved.

### (Fourth Aspect)

In a fourth aspect, a case where maximum power reduction (MPR) is controlled on the basis of a NW class or a NW type in an adjacent band will be described.

A system including a plurality of coexisting NWs prevents interference between systems by separating a frequency band to be used by the NWs. However, a transmitter to radiate a radio wave radiates an unnecessary wave (hereinafter referred to as adjacent channel interference) in a band outside of a frequency band for its own system, thereby leading a plurality of adjacent systems to give interference to each other even though the frequency band is separated. Accordingly, a power level of the above-described unnecessary wave being high leads to a great negative impact on the adjacent systems.

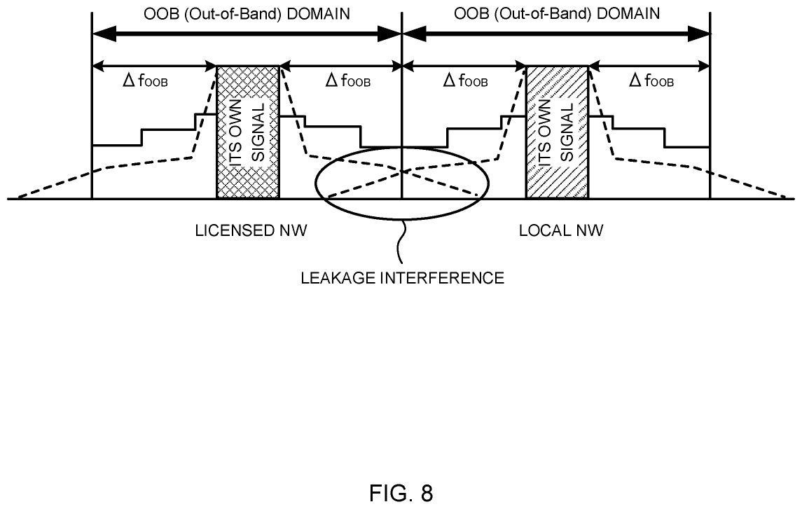

For example, when a frequency band for a licensed NW is adjacent to a frequency band for a local NW, leakage interference from the licensed NW to the local NW and leakage interference from the local NW to the licensed NW may occur (see FIG. 8). When a plurality of local NWs exists in a common frequency bandwidth or adjacent frequency bandwidths, leakage interference from a local NW to another local NW may also occur.

In order to suppress the unnecessary wave to the outside of a system band, reduction of maximum transmit power under given conditions is defined. The reduction of the maximum transmit power is referred to as MPR.

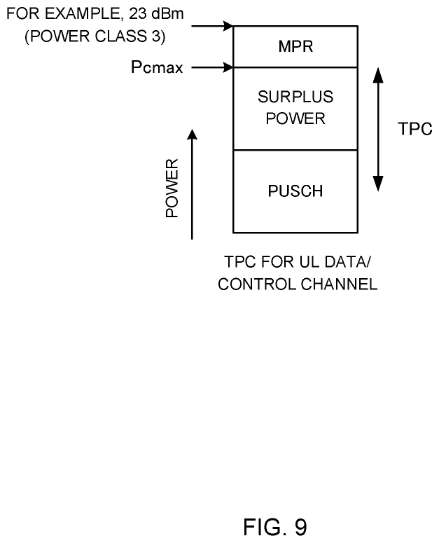

The maximum transmit power of the UE may be defined depending on a power class. For example, in a case of class 3, the maximum transmit power is a given value (e.g., 23 dBm). When maximum power reduction (MPR) is performed to limit unnecessary radiation to a given value or less, it is assumed that actual maximum transmit power (Pcmax) is configured within a given range (see FIG. 9). The UE may assume that transmit power control (e.g., TPC) is controlled using Pcmax bas a maximum value.

In the aspects of the present embodiment, a value of MPR may be controlled on the basis of a NW class or a NW type in a frequency band adjacent to a frequency band for each NW.

### <MPR Configuration in Local NW>

A value of MPR configured for a local NW may be determined on the basis of a NW class or a NW type in a frequency band adjacent to a frequency band for the local NW. In other words, in addition to a system bandwidth, a transmission bandwidth, and MCS (particularly modulation scheme), an MPR configuration value may be determined depending on which one of a local NW and licensed NW is configured in an adjacent band.

When at least one adjacent band is a licensed NW, MPR greater than a given value (e.g., a value configured in a case where the adjacent band is a local NW) may be configured.

A plurality of business operators is assumed to operate or install a station in a local NW, and thus it is difficult to perform cell planning, and leakage interference to an adjacent band is assumed to be greater. Thus, increasing the MPR configuration value suppresses interference to the licensed NW, and thus quality of communication in the licensed NW can be improved.

Alternatively, when at least one adjacent band is a local NW, MPR greater than a given value (e.g., a value configured in a case where the adjacent band is a licensed NW) may be configured.

A local NW is assumed to perform a service with strict requirements for a factory, a hospital, or the like, and thus leakage interference to an adjacent band is assumed to have large impact. Thus, increasing the MPR configuration value suppresses interference to the local NW, and thus quality of communication in the local NW can be improved.

### <MPR Configuration in Licensed NW>

A value of MPR configured for a licensed NW may be determined on the basis of a NW class or a NW type in a frequency band adjacent to a frequency band for the licensed NW. In other words, in addition to a system bandwidth, a transmission bandwidth, and MCS (particularly modulation scheme), an MPR configuration value may be determined depending on whether a local NW is configured in an adjacent band.

When at least one adjacent band is a local NW, MPR greater than a given value (e.g., a value configured in a case where the adjacent band is a licensed NW) may be configured.

A local NW is assumed to perform a service with strict requirements for a factory, a hospital, or the like, and thus leakage interference to an adjacent band is assumed to have large impact. Thus, increasing the MPR configuration value suppresses interference to the local NW, and thus quality of communication in the local NW can be improved.

### (Variations)

The UE or network may apply variations described below in the above-described first aspect to fourth aspect.

<Measurement of Frequency Band for NWs with Different Carrier IDs>

The UE may perform a cell search in a frequency band (or CC) for networks (or cells) with different business operator IDs, or may perform measurement of at least one of signal power, interference power, RSRP, RSRQ, SINR, and CQI. The UE may report a result of the measurement in a frequency band (or CC) for networks (or cells) with the same business operator ID. Alternatively, the UE may report the result of the measurement in a frequency band (or CC) for networks (or cells) with different business operator IDs. Therefore, interference in a frequency band for another business operator can be acquired.

### <Interference Report for Local NW>

In a local NW (or local 5G cell), an interference report below may be applied.

The UE measures RSRP of a surrounding cell (or NW), and reports a received signal level (or interference level) to the NW. Contents of the report may be at least one of signal power, interference power, RSRP, RSRQ, SINR, and CQI. The base station performs interference control on the basis of contents reported from the UE.

The interference report from the UE may include both a UE triggering type and a base station triggering type. In the UE triggering type, when a signal level (or interference level) measured by the UE is greater (or less) than a given value or a threshold value configured by a higher layer, the signal level is reported to the network. In the base station triggering type, the UE indicated to report to the base station (or NW) reports a signal level (or interference level) to the base station. The UE may include a cell ID of the surrounding cell and the like in the contents of the report.

Note that the above-described interference report may be performed by using a scheme similar to Closed subscriber group (CSG) that permits only a certain UE in existing systems to access, Open subscriber group (OSG) that permits all UEs to access, or Hybrid subscriber group (HSG) that broadcasts, together with CSG ID, whether a cell is open to a UE that does not belong to CSG by using a 1-bit flag and handles the cell similarly to a CSG cell when the cell belongs to CSG and similarly to a normal cell when the cell does not belong to CSG, for example.

### <Uplink Control Channel/Uplink Reference Signal>

Each NW (or base station) may perform interference measurement for UL by using at least one of an uplink channel and an uplink reference signal transmitted from the UE. The uplink channel may be at least one of an uplink shared channel (PUSCH) and an uplink control channel (PUCCH). The uplink reference signal may be a sounding reference signal (SRS).

The UE transmits at least one of the uplink channel and the uplink reference signal to networks (or cells, CCs) with the same business operator ID. In this case, the UE may assume that transmission of the uplink channel and the uplink reference signal to a network of a different business operator ID is not configured.

Alternatively, the UE may also transmit at least one of the uplink channel and the uplink reference signal to a network (or cell, CC) with a different business operator ID. For example, when a network configures or triggers transmission of an SRS, the UE may transmit the SRS periodically (P-SRS), semi-persistently (SP-SRS), or aperiodically (A-SRS). The UE may control so as to transmit the SRS when a measured interference level of a DL reference signal is a given value or more.

When transmitting the SRS on the basis of a judgment by the UE (UE triggering), the UE may perform transmission of the SRS by using a resource (e.g., a periodic SRS resource) configured by higher layer signaling. Alternatively, the UE may select an SRS resource corresponding to at least one of P-SRS, SP-SRS, and A-SRS out of SRS resources configured by higher layer signaling to perform transmission of the SRS.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

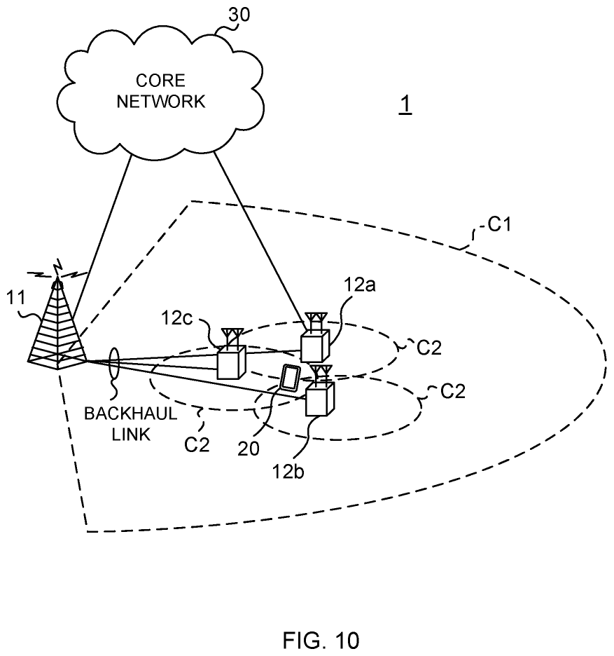

FIG. 10 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

Note that respective base stations 11 and 12a to 12c may be operated by different business operators. Alternatively, the base stations 11 and 12a may be operated by the same business operator, and the base stations 12b and 12c may be operated by different business operators. A licensed NW may be operated by the base station 11, and a local NW may be operated by each of the base stations 12a to 12c.

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

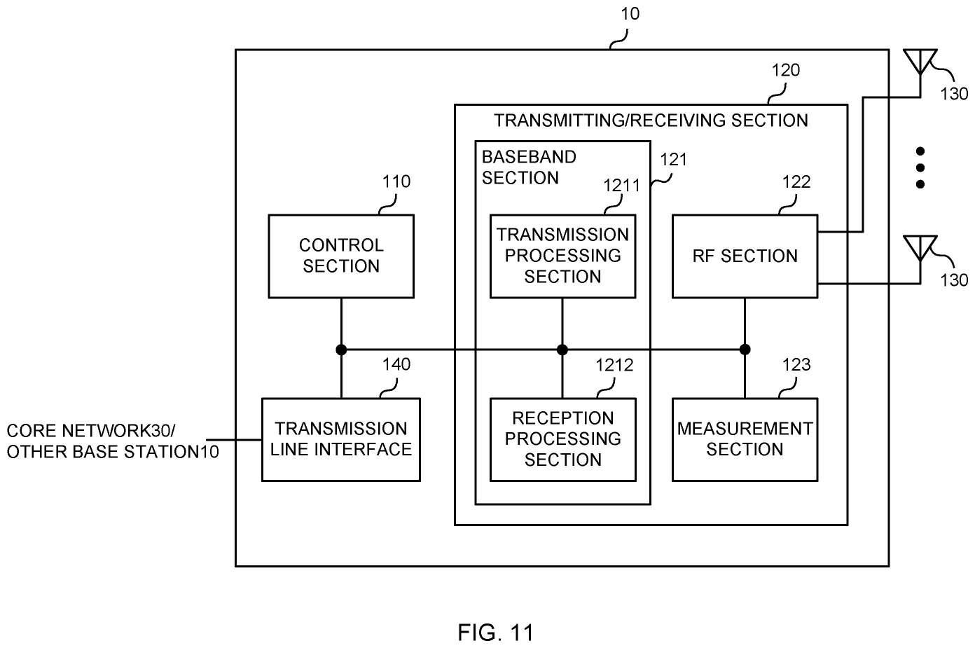

FIG. 11 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 transmits information related to a resource for measurement in a network. The transmitting/receiving section 120 transmits information related to an indication of interference control. The transmitting/receiving section 120 receives information related to a measurement result.

The control section 110 performs interference control on the basis of information reported from the UE.

### (User Terminal)

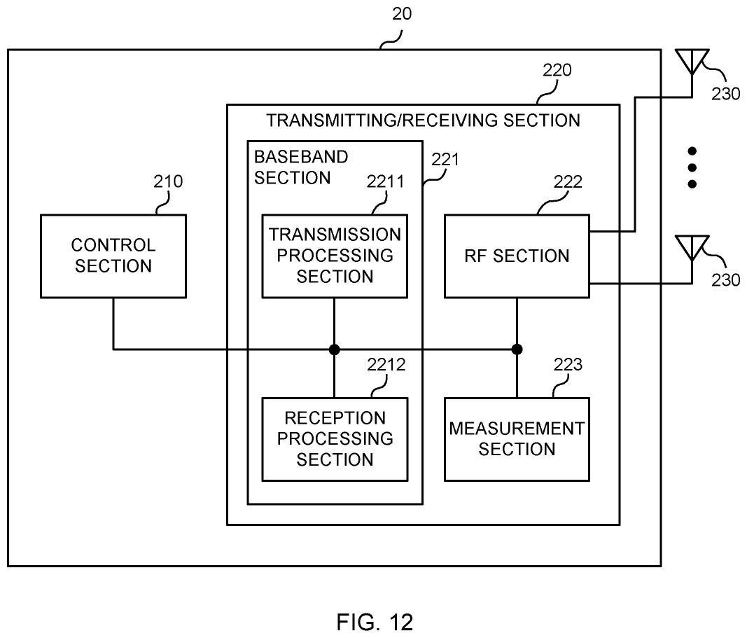

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that transmitting/receiving section 220 may receive, from at least one of a first network (e.g., a licensed NW) and a second network (e.g., a local NW) of a business operator different from that for the first network, information related to a resource for measurement in the second network. The transmitting/receiving section 220 may transmit information including a result of measurement by the resource for measurement to at least one of the first network and the second network. The transmitting/receiving section 220 may receive, from the first network, information related to an indication of interference control.

The control section 210 may control information including a result of measurement by the resource for measurement to be reported to at least one of the first network and the second network.

The control section 210 may determine, on the basis of given information transmitted from the first network, at least one of a sequence and a location applied to a signal transmitted in the second network or a signal received in the second network.

When the given information is not received, the control section 210 may determine, on the basis of a given index, at least one of a sequence and a location applied to a signal transmitted in the second network or a signal received in the second network.

Transmit power configured in the second network may be controlled on the basis of MPR configured depending on classification of a network that uses a frequency band adjacent to a frequency band for the second network.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

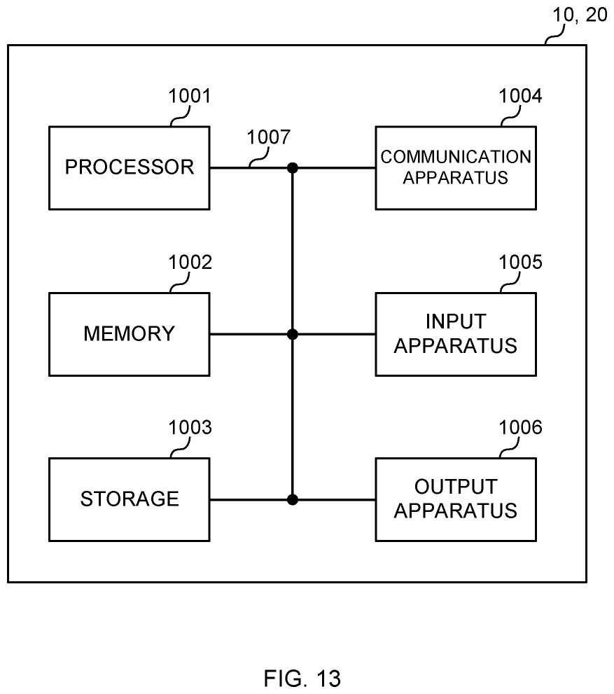

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A user terminal comprising:
a receiving section that receives, from at least one of a first network and a second network of a business operator different from a business operator for the first network, information related to a resource for measurement in the second network; and
a control section that controls information including a result of measurement by the resource for measurement to be reported to at least one of the first network and the second network.

2. The user terminal according to claim 1, wherein the receiving section receives, on the basis of a report of the information including the result of the measurement, information related to an indication of interference control from the first network.

3. The user terminal according to claim 1, wherein the control section determines, on the basis of given information transmitted from the first network, at least one of a sequence and a location applied to a signal transmitted in the second network or a signal received in the second network.

4. The user terminal according to claim 3, wherein when the given information is not received, the control section determines, on the basis of a given index, at least one of a sequence and a location applied to a signal transmitted in the second network or a signal received in the second network.

5. The user terminal according to claim 1, wherein transmit power configured in the second network is controlled on the basis of MPR (Maximum power reduction) configured depending on classification of a network that uses a frequency band adjacent to a frequency band for the second network.

6. A radio communication method comprising:
receiving, from at least one of a first network and a second network of a business operator different from a business operator for the first network, information related to a resource for measurement in the second network; and
controlling information including a result of measurement by the resource for measurement to be reported to at least one of the first network and the second network.

7. The user terminal according to claim 2, wherein the control section determines, on the basis of given information transmitted from the first network, at least one of a sequence and a location applied to a signal transmitted in the second network or a signal received in the second network.

8. The user terminal according to claim 2, wherein transmit power configured in the second network is controlled on the basis of MPR (Maximum power reduction) configured depending on classification of a network that uses a frequency band adjacent to a frequency band for the second network.

9. The user terminal according to claim 3, wherein transmit power configured in the second network is controlled on the basis of MPR (Maximum power reduction) configured depending on classification of a network that uses a frequency band adjacent to a frequency band for the second network.

10. The user terminal according to claim 4, wherein transmit power configured in the second network is controlled on the basis of MPR (Maximum power reduction) configured depending on classification of a network that uses a frequency band adjacent to a frequency band for the second network.
